(19) United States
(12) Patent Application Publication
(10) Pub. No.: US 2024/0255898 A1
(43) Pub. Date: Aug. 1, 2024

(54) MEASURING DEVICE, MEASURING METHOD, AND TIME SYNCHRONIZATION SYSTEM

(71) Applicant: NIPPON TELEGRAPH AND TELEPHONE CORPORATION, Tokyo (JP)

(72) Inventors: Keisuke YAMAGATA, Tokyo (JP); Go YAZAWA, Tokyo (JP); Shinichi YOSHIHARA, Tokyo (JP); Takashi NAKANISHI, Tokyo (JP)

(73) Assignee: NIPPON TELEGRAPH AND TELEPHONE CORPORATION, Tokyo (JP)

(21) Appl. No.: 18/560,905

(22) PCT Filed: May 19, 2021
(86) PCT No.: PCT/JP2021/019029

§ 371 Date: Nov. 14, 2023

(51) Int. Cl. G04R 20/02

(52) U.S. Cl. CPC G04R 20/02

(57) ABSTRACT

A measurement instrument (30) according to the present disclosure includes: a UTC acquisition unit (31) configured to acquire a reference time from a satellite signal; a BC time acquisition unit (32) configured to acquire time information regarding an in-device time of a first device (3); a UTC-BC offset calculation processing unit (33) configured to calculate a first offset that is a difference between the reference time and the in-device time of the first device (3) based on the reference time and the time information; a BC-client offset calculation processing unit (34) configured to acquire a copy of the packet and calculate a second offset that is a difference between the in-device time of the first device (3) and the in-device time of the second device (4) based on the acquired packet and a transmission delay between the first device (3) and the second device (4); and a time accuracy calculation processing unit (35) configured to measure accuracy of an in-device time of the second device (4) with respect to the reference time based on the first and second offsets.

### TECHNICAL FIELD

The present disclosure relates to a measurement instrument, a measurement method, and a time synchronization system.

### BACKGROUND ART

A precision time protocol (PTP) defined by the IEEE-1588 standard is a protocol that synchronizes a time (in-device time) of a computer on a local area network (LAN) with high accuracy (see Non Patent Literature 1). FIG. 10 is a diagram illustrating an exemplary configuration of a conventional time synchronization system 1a that synchronizes times of devices on a network using a PTP protocol.

A time synchronization system 1a illustrated in FIG. 10 includes a grand master clock 100, a client device 200, and a measurement instrument 300. The grand master clock 100 and the client device 200 can communicate with each other via the network 2 such as a LAN.

The grand master clock 100 includes a global navigation satellite system (GNSS) antenna that receives a signal (GNSS signal) from a satellite of a GNSS such as the Global Positioning System (GPS). The grand master clock 100 receives a GNSS signal via a GNSS antenna, and acquires universal time coordinated (UTC) from the received GNSS signal. The grand master clock 100 has a master function of delivering the acquired UTC as a reference time via the network 2.

The client device 200 has a slave function of synchronizing an in-device time with a time delivered from a device that has a master function. In the time synchronization system 1a illustrated in FIG. 10, the grand master clock 100 is a device that has a master function, and the client device 200 synchronizes the in-device time with the time delivered from the grand master clock 100. The client device 200 is, for example, a base station device in a mobile phone network.

As a measurement method of measuring accuracy of the in-device time of the client device 200, as illustrated in FIG. 10, there is a method in which a measurement instrument 300 synchronized with the GNSS (synchronized with the time delivered by the GNSS) is connected to the client device 200, and signal quality of a timing reference signal such as a 1 pulse per second (PPS) signal output by the client device 200 is compared with a time delivered by the GNSS (for example, see Non Patent Literature 2.). The 1PPS signal is a signal output at one pulse per second. The 1PPS signal is input from the client device 200 to the measurement instrument 300, for example, by connecting the client device 200 to the measurement instrument 300 by a coaxial cable. Therefore, it is necessary install the client device 200 and the measurement instrument 300 in a range in which connection by a coaxial cable is possible, for example, in the same building or the like.

### CITATION LIST

### Non Patent Literature

Non Patent Literature 1: IEEE Std 1588™-2019 “IEEE Standard for a Precision Clock Synchronization Protocol for Networked Measurement and Control Systems”

Non Patent Literature 2: ITU-T G. 8273/Y. 1368 “Framework of phase and time clocks”

### SUMMARY OF INVENTION

### Technical Problem

In the measurement method of the related art described with reference to FIG. 10, there arises a constraint that a GNSS antenna capable of receiving a GNSS signal is required at a measurement location, or a constraint that the GNSS signal is received for a sufficient time in advance, the measurement instrument 300 synchronized with the GNSS is carried to the measurement location while the synchronization is lost, and it is necessary to perform measurement. Therefore, in the measurement method of the related art, there is a problem that preliminary environmental maintenance and a large amount of human operation are required in order to measure accuracy of an in-device time. There is a problem that measurement may be difficult due to a constraint that a GNSS antenna is required or a constraint that it is necessary to perform measurement while synchronization of the measurement instrument 300 is lost.

An object of the present disclosure made in view of the above-described problems is to provide a measurement instrument, a measurement method, and a time synchronization system capable of relaxing the above-described constraints and measuring the accuracy of the in-device time more simply.

### Solution to Problem

In order to solve the foregoing problem, a measurement instrument according to an aspect of the present disclosure is a measurement instrument that measures accuracy of an in-device time of a second device with respect to a reference time in the second device that synchronizes the in-device time with the reference time and synchronizes the in-device time with a first device by transmitting and receiving a packet to and from the first device that delivers the in-device time. The measurement instrument includes: a first acquisition unit configured to acquire the reference time from a satellite signal; a second acquisition unit configured to acquire time information regarding an in-device time of the first device; a first calculation processing unit configured to calculate a first offset that is a difference between the reference time and the in-device time of the first device based on the reference time acquired by the first acquisition unit and the time information acquired by the second acquisition unit; a second calculation processing unit configured to acquire a copy of the packet transmitted and received between the first and second devices, and calculate a second offset that is a difference between the in-device time of the first device and the in-device time of the second device based on the acquired packet and a transmission delay between the first and second devices; and a third calculation processing unit configured to measure accuracy of the in-device time of the second device with respect to the reference time based on the first and second offsets.

In order to solve the above problem, a measurement method according to another aspect of the present disclosure is a measurement method by a measurement instrument that measures accuracy of an in-device time of a second device with respect to a reference time in the second device that synchronizes the in-device time with the reference time and synchronizes the in-device time with a first device by transmitting and receiving a packet to and from the first device that delivers the in-device time. The measurement method includes: a step of acquiring the reference time from a satellite signal; a step of acquiring time information regarding an in-device time of the first device; a step of calculating a first offset that is a difference between the reference time and the in-device time of the first device based on the acquired reference time and the acquired time information; a step of acquiring a copy of the packet transmitted and received between the first and second devices, and calculating a second offset that is a difference between the in-device time of the first device and the in-device time of the second device based on the acquired packet and a transmission delay between the first and second devices; and a step of measuring accuracy of the in-device time of the second device with respect to the reference time based on the first and second offsets.

In order to solve the above problem, a time synchronization system according to still another aspect of the present disclosure is a time synchronization system including: a first device configured to synchronize an in-device time with a reference time and deliver the in-device time;
a second device configured to synchronize an in-device time with the first device by transmitting and receiving a packet to and from the first device; and a measurement instrument configured to measure accuracy of an in-device time of the second device with respect to the reference time in the second device. The measurement instrument includes: a first acquisition unit configured to acquire the reference time from a satellite signal; a second acquisition unit configured to acquire time information regarding an in-device time of the first device; a first calculation processing unit configured to calculate a first offset that is a difference between the reference time and the in-device time of the first device based on the reference time acquired by the first acquisition unit and the time information acquired by the second acquisition unit; a second calculation processing unit configured to acquire a copy of the packet transmitted and received between the first and second devices, and calculate a second offset that is a difference between the in-device time of the first device and the in-device time of the second device based on the acquired packet and a transmission delay between the first and second devices; and a third calculation processing unit configured to measure accuracy of the in-device time of the second device with respect to the reference time based on the first and second offsets.

### Advantageous Effects of Invention

According to the measurement instrument, the measurement method, and the time synchronization system according to the present disclosure, it is possible to more easily measure accuracy of an in-device time.

### BRIEF DESCRIPTION OF DRAWINGS

FIG. 1 is a diagram illustrating an overview of an operation of a measurement instrument according to the present disclosure.

FIG. 2 is a diagram illustrating an exemplary configuration of a time synchronization system according to an embodiment of the present disclosure.

FIG. 3 is a flowchart illustrating an example of an operation of the measurement instrument illustrated in FIG. 2.

FIG. 4 is a diagram illustrating calculation of a second offset by a BC-client offset calculation processing unit illustrated in FIG. 2.

FIG. 5 is a diagram illustrating calculation of a transmission delay by a transmission delay calculation processing unit illustrated in FIG. 2.

FIG. 6 is a diagram illustrating an exemplary configuration of a time synchronization system according to another embodiment of the present disclosure.

FIG. 7 is a diagram illustrating an exemplary configuration of a time synchronization system according to still another embodiment of the present disclosure.

FIG. 8 is a diagram illustrating calculation of a second offset by a BC-client offset calculation processing unit illustrated in FIG. 7.

FIG. 9 is a diagram illustrating an example of a hardware configuration of the measurement instrument according to the present disclosure.

FIG. 10 is a diagram illustrating an exemplary configuration of a time synchronization system of the related art.

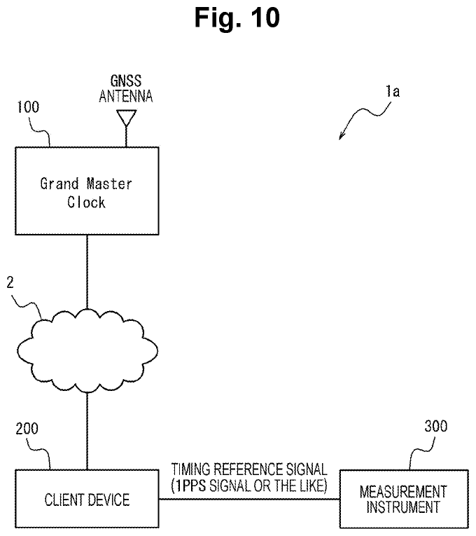

### DESCRIPTION OF EMBODIMENTS

Hereinafter, embodiments of the present disclosure will be described with reference to the drawings.

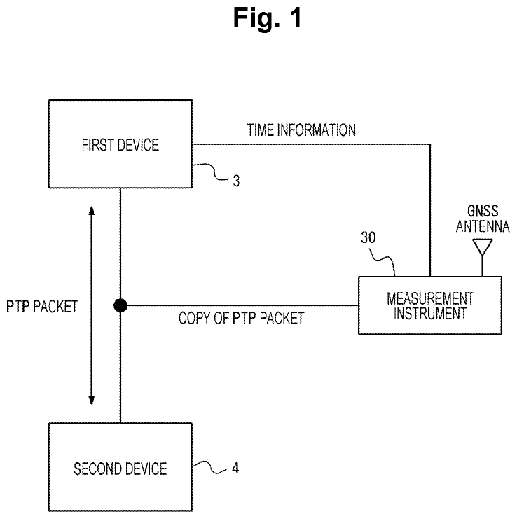

First, an overview of a measurement instrument 30 according to the present disclosure will be described with reference to FIG. 1.

The measurement instrument 30 according to the present disclosure is a device that measures accuracy of an in-device time of a second device 4 with respect to a reference time in the second device 4 that synchronizes the in-device time with a first device 3 by transmitting and receiving a PTP packet to and from the first device 3. The first device 3 is a device that has a master function of synchronizing an in-device time with a reference time (UTC or a time delivered from another device) and delivering the in-device time. The other device is a device that is provided above the first device 3 and has a master function. The second device 4 is a device that has a slave function of synchronizing an in-device time with a time delivered from the first device 3 that has a master function.

The measurement instrument 30 acquires a copy of the PTP packet transmitted and received between the first device 3 and the second device 4. Accordingly, in the present embodiment, in order to copy mutual communication (both upstream and downstream communication) between the first device 3 and the second device 4, a copy point for copying a PTP packet is provided between the first device 3 and the second device 4. The measurement instrument 30 acquires a copy of the PTP packet via the copy point. Hereinafter, acquisition of a copy of the PTP packet by the measurement instrument 30 via the copy point is simply described as “acquisition of the PTP packet” in some cases.

The measurement instrument 30 acquires time information regarding an in-device time of the first device 3. The measurement instrument 30 acquires a GNSS signal through a GNSS antenna and acquires a reference time (UTC) from the acquired GNSS signal. The measurement instrument 30 measures accuracy of the in-device time of the second device 4 with respect to the reference time based on the acquired PTP packet, the reference time, and the time information.

The measurement instrument 30 acquires a copy of the PTP packet and measures the accuracy of the in-device time of the second device 4 with respect to the reference time using the acquired PTP packet. Then, it is not necessary to carry the measurement instrument 30 to an installation location of the second device 4 when measurement is performed. It is possible to alleviate a constraint such as bringing of the measurement instrument 300 synchronized with the installation location of the GNSS antenna and the reference time as in the time synchronization system 1a of the related art. Therefore, the measurement instrument 30 according to the present disclosure can measure the accuracy of the in-device time more easily. The measurement instrument 30 according to the present disclosure remotely measure the accuracy of the in-device time of the second device 4. Therefore, it is possible to promptly perform maintenance countermeasures when the time error occurs.

Note that, in the present disclosure, it is sufficient that the first device 3 that has the master function and the second device 4 that has the slave function can transmit and receive the PTP packet. Therefore, there is no constraint that the first device 3 and the second device 4 are installed in the same building.

Further, the constraint of the installation positions of the first device 3 and the measurement instrument 30 varies depending on a method of acquiring the time information. When the measurement instrument 30 acquires the time information from a 1PPS signal output from the first device 3 to be described below, it is necessary to connect the first device 3 to the measurement instrument 30 by a coaxial cable. Therefore, it is necessary to install the first device 3 and the measurement instrument 30 in a range in which the first device 3 and the measurement instrument 30 can be connected by a coaxial cable, for example, in a range within tens of meters. When the measurement instrument 30 acquires the time information from the PTP packet output from the first device 3 to be described below, it is sufficient that the first device 3 and the measurement instrument 30 can transmit and receive the PTP packet. Therefore, there is no constraint that the first device 3 and the measurement instrument 30 are installed in the same building.

In the present disclosure, it is sufficient that the measurement instrument 30 may copy and acquire the PTP packet transmitted and received between the first device 3 and the second device 4. Therefore, there is no constraint that the second device 4 and the measurement instrument 30 are installed in the same building.

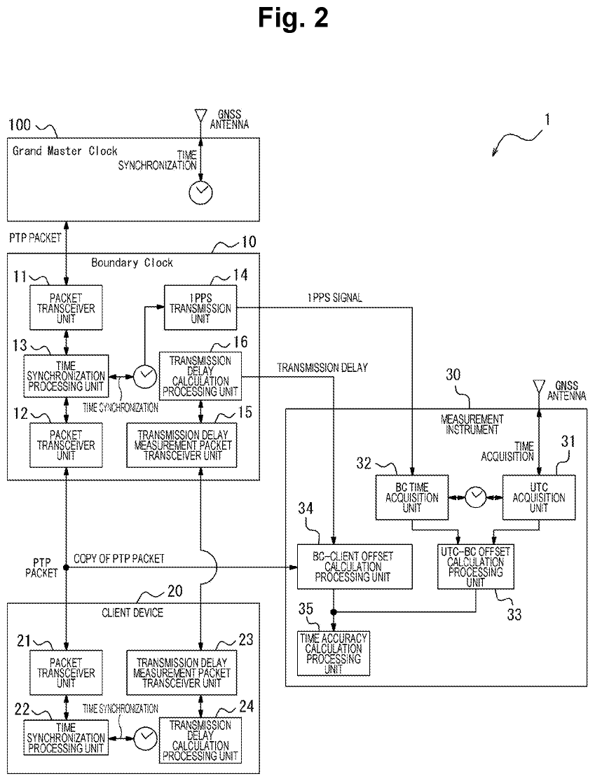

Next, a configuration of the time synchronization system 1 according to the present embodiment will be described with reference to FIG. 2.

As illustrated in FIG. 2, the time synchronization system 1 according to the present embodiment includes a boundary clock 10, a client device 20, and a measurement instrument 30.

The boundary clock 10 functions as a device that has a slave function with respect to a superordinate device that has a master function and functions as a device that has a master function with respect to a subordinate device that has a slave function. In the present embodiment, the boundary clock 10 functions as a device that has a slave function with respect to the grand master clock 100, and functions as a device that has a master function with respect to the client device 20. Therefore, the boundary clock 10 synchronizes the in-device time of the boundary clock 10 with the time (the reference time) delivered from the grand master clock 100 by transmitting and receiving the PTP packet to and from the grand master clock 100. The boundary clock 10 delivers the in-device time to the client device 20 by transmitting and receiving the PTP packet to and from the client device 20. The boundary clock 10 outputs a pulse signal (1PPS signal) to the measurement instrument 30 at 1PPS in synchronization with the in-device time of the boundary clock 10 as time information regarding the in-device time of the boundary clock 10. The boundary clock 10 calculates a packet transmission delay with the client device 20 and outputs a calculation result of the transmission delay to the measurement instrument 30.

The client device 20 synchronizes the in-device time with the time delivered from the boundary clock 10 by transmitting and receiving the PTP packet to and from the boundary clock 10. Accordingly, in the time synchronization system illustrated in FIG. 2, the boundary clock 10 corresponds to the first device 3 that has the master function, and the client device 20 corresponds to the second device 4 that has the slave function.

The measurement instrument 30 measures the accuracy of the in-device time with respect to the reference time in the client device 20 as the second device 4. The measurement instrument 30 acquires a copy of the PTP packet transmitted and received between the boundary clock 10 and the client device 20. The measurement instrument 30 measures an error of the accuracy of the in-device time with respect to the reference time in the client device 20 based on the acquired PTP packet, the 1PPS signal, and the transmission delay between the boundary clock 10 and the client device 20.

Next, configurations of the boundary clock 10, the client device 20, and the measurement instrument 30 will be described with reference to FIG. 2. First, the configuration of the boundary clock 10 will be described.

As illustrated in FIG. 2, the boundary clock 10 includes packet transceiver units 11 and 12, a time synchronization processing unit 13, a 1PPS transmission unit 14, a transmission delay measurement packet transceiver unit 15, and a transmission delay calculation processing unit 16.

The packet transceiver unit 11 transmits and receives the PTP packet to and from the grand master clock 100. The packet transceiver unit 12 transmits and receives the PTP packet to and from the client device 20.

The time synchronization processing unit 13 acquires the time delivered by the grand master clock 100 from the PTP packet acquired from the grand master clock 100 via the packet transceiver unit 11, and synchronizes the in-device time of the boundary clock 10 with the acquired time.

The 1PPS transmission unit 14 outputs the pulse signal (the 1PPS signal) to measurement instrument 30 at 1PPS in synchronization with the in-device time of the boundary clock 10.

The transmission delay measurement packet transceiver unit 15 transmits and receives a packet (a transmission delay measurement packet) for measuring a transmission delay between the boundary clock 10 and the client device 20 to and from the client device 20.

The transmission delay calculation processing unit 16 calculates a transmission delay between the boundary clock 10 and the client device 20 from the transmission delay measurement packets transmitted and received by the transmission delay measurement packet transceiver unit 15. The transmission delay calculation processing unit 16 outputs a calculation result of the transmission delay to the measurement instrument 30.

First, the configuration of the client device 20 will be described.

As illustrated in FIG. 2, the client device 20 includes a packet transceiver unit 21, a time synchronization processing unit 22, a transmission delay measurement packet transceiver unit 23, and a transmission delay calculation processing unit 24.

The packet transceiver unit 21 transmits and receives the PTP packet to and from the boundary clock 10.

The time synchronization processing unit 22 acquires the time delivered by the boundary clock 10 from the PTP packet received from the boundary clock 10 via the packet transceiver unit 21, and synchronizes the in-device time of the client device 20 with the acquired time.

The transmission delay measurement packet transceiver unit 23 transmits and receives the transmission delay measurement packet to and from the boundary clock 10.

A transmission delay between boundary clock 10 and the client device 20 is calculated from the transmission delay measurement packets transmitted and received by the transmission delay calculation processing unit 24 and the transmission delay measurement packet transceiver unit 23.

Next, a configuration of the measurement instrument 30 will be described.

As illustrated in FIG. 2, the measurement instrument 30 includes a UTC acquisition unit 31, a BC time acquisition unit 32, a UTC-BC offset calculation processing unit 33, a BC-client offset calculation processing unit 34, and a time accuracy calculation processing unit 35.

The UTC acquisition unit 31 serving as a first acquisition unit receives a GNSS signal that is a satellite signal transmitted from a GNSS satellite via a GNSS antenna. The UTC acquisition unit 31 acquires a reference time (UTC) from the received GNSS signal and synchronizes the in-device time of the measurement instrument 30 with the acquired time. The UTC acquisition unit 31 outputs the obtained time to the UTC-BC offset calculation processing unit 33.

The BC time acquisition unit 32 serving as a second acquisition unit acquires time information regarding the in-device time of the boundary clock 10. In the present embodiment, the BC time acquisition unit 32 acquires a 1PPS signal that is a pulse signal output from the boundary clock 10 at 1PPS in synchronization with the in-device time of the boundary clock 10, and acquires time information regarding the in-device time of the boundary clock 10 from the acquired 1PPS signal. The BC time acquisition unit 32 outputs the acquired in-device time of the boundary clock 10 to the UTC-BC offset calculation processing unit 33.

The UTC-BC offset calculation processing unit 33 serving as a first calculation processing unit calculates a first offset that is a difference between UTC and the in-device time of the boundary clock 10 based on the reference time (UTC) acquired by the UTC acquisition unit 31 and the in-device time of the boundary clock 10 acquired by the BC time acquisition unit 32. The UTC-BC offset calculation processing unit 33 outputs the calculated first offset to the time accuracy calculation processing unit 35.

The BC-client offset calculation processing unit 34 serving as a second calculation processing unit acquires a copy of the PTP packet transmitted and received between the boundary clock 10 and the client device 20. The BC-client offset calculation processing unit 34 calculates a second offset which is a difference between the in-device time of the boundary clock 10 and the in-device time of the client device 20 based on the acquired PTP packet and the transmission delay between the boundary clock 10 and the client device 20. The BC-client offset calculation processing unit 34 outputs the calculated second offset to the time accuracy calculation processing unit 35.

The time accuracy calculation processing unit 35 serving as a third calculation processing unit measures the accuracy of the in-device time of the client device 20 with respect to the reference time (UTC) based on the first offset calculated by the UTC-BC offset calculation processing unit 33 and the second offset calculated by the BC-client offset calculation processing unit 34.

The measurement instrument 30 acquires the PTP packet and measures the accuracy of the in-device time of the client device 20 with respect to the reference time using the acquired PTP packet, and thus it is not necessary to carry the measurement instrument 30 to the installation location of the client device 20 when measurement is performed. It is possible to alleviate a constraint such as bringing of the measurement instrument 300 synchronized with the installation location of the GNSS antenna and the reference time as in the time synchronization system 1a of the related art. Therefore, the measurement instrument 30 according to the present disclosure can measure the accuracy of the in-device time more easily. Furthermore, the measurement instrument 30 according to the present disclosure can remotely measure the accuracy of the in-device time of the client device 20. Therefore, it is possible to promptly perform maintenance countermeasures when a time error occurs.

In FIG. 2, an example in which the boundary clock 10 is the first device 3 and the client device 20 is the second device 4 has been described, but the present disclosure is not limited thereto. For example, the grand master clock 100 that has the master function may be the first device 3, the boundary clock 10 that has the slave function may be the second device 4, and the measurement instrument 30 may measure the accuracy of the in-device time in the boundary clock 10.

Next, an operation of the measurement instrument 30 according to the present embodiment will be described.

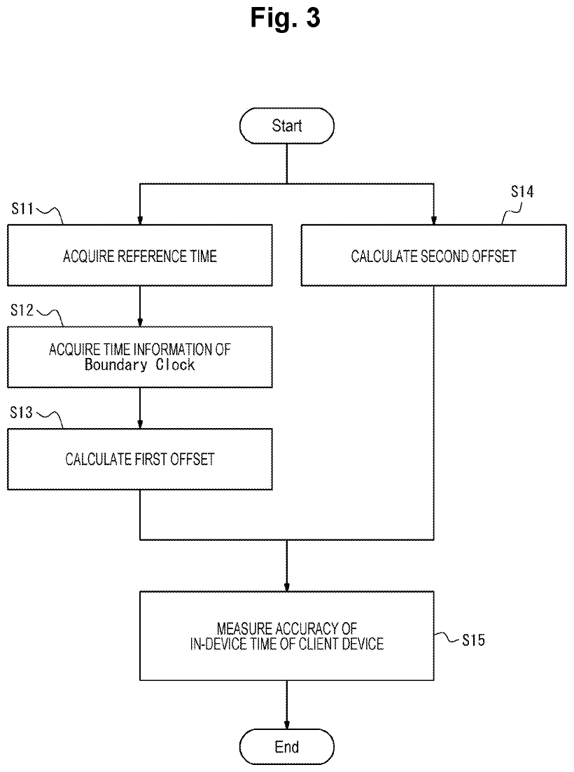

FIG. 3 is a flowchart illustrating an example of an operation of the measurement instrument 30 according to the present embodiment and is a diagram illustrating a measurement method by the measurement instrument 30.

The UTC acquisition unit 31 acquires a reference time (UTC) from a GNSS signal received from a satellite via the GNSS antenna (step S11).

The BC time acquisition unit 32 acquires time information regarding the in-device time of boundary clock 10 serving as the first device 3 (step S12). In the time synchronization system 1 illustrated in FIG. 2, the BC time acquisition unit 32 acquires time information from the 1PPS signal output from the boundary clock 10.

The UTC-BC offset calculation processing unit 33 calculates a first offset that is a difference between the reference time and the in-device time of boundary clock 10 based on the reference time (UTC) acquired by the UTC acquisition unit 31 and the time information acquired by the BC time acquisition unit 32 (step S13). Hereinafter, it is assumed that the first offset is X seconds.

The BC-client offset calculation processing unit 34 acquires a copy of the PTP packet transmitted and received between the boundary clock 10 and the client device 20. The BC-client offset calculation processing unit 34 calculates the second offset which is a difference between the in-device time of the boundary clock 10 and the in-device time of the client device 20 based on the acquired PTP packet and the transmission delay between the boundary clock 10 and the client device 20 (step S14). Hereinafter, it is assumed that the second offset is Y seconds. Details of the calculation of the second offset will be described below.

In FIG. 3, the processes from steps S11 to S13 and the process of step S14 are illustrated as being branched. Actually, these processes are not branched and are sequentially performed.

The time accuracy calculation processing unit 35 measures the accuracy of the in-device time of the client device 20 with respect to the reference time based on the first offset calculated by the UTC-BC offset calculation processing unit 33 and the second offset calculated by the BC-client offset calculation processing unit 34 (step S15). For example, the time accuracy calculation processing unit 35 calculates a difference (offset) between the reference time and the in-device time of the client device 20 as the accuracy of the in-device time of the client device 20 with respect to the reference time. Specifically, the time accuracy calculation processing unit 35 calculates the offset between the reference time and the in-device time of the client device 20 by the sum (X+Y) of the first offset (X seconds) and the second offset (Y seconds).

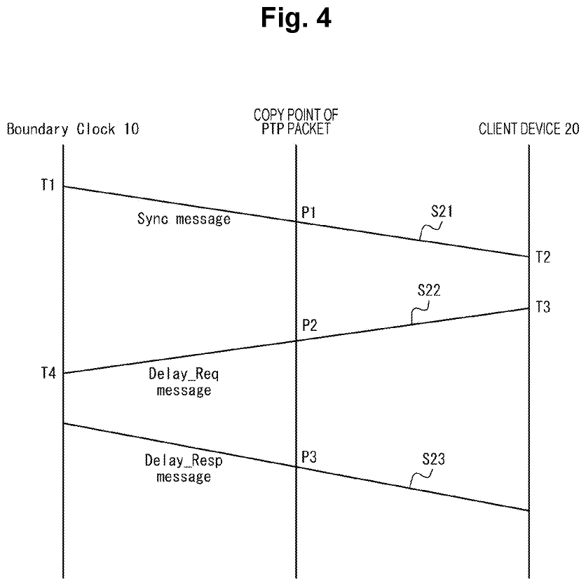

Next, calculation of the second offset by the BC-client offset calculation processing unit 34 will be described with reference to FIG. 4.

First, a message transmitted and received between the boundary clock 10 and the client device 20 according to the PTP will be described. A message transmitted and received between the boundary clock 10 and the client device 20 includes one or a plurality of PTP packets.

As illustrated in FIG. 4, the boundary clock 10 first transmits a Sync message to the client device 20 (step S21). The boundary clock 10 includes a timestamp indicating time T1 (first time), which is the transmission time of the Sync message, in the Sync message and transmits the Sync message to the client device 20.

When receiving the Sync message transmitted from the boundary clock 10 at time T2 (second time), the client device 20 transmits Delay_Req message to the boundary clock 10 at time T3 in response to the Sync message (step S22). The client device 20 includes a timestamp indicating time T3 (third time) which is the transmission time of the Delay_Req message in the Delay_Req message and transmits the Delay_Req message to the boundary clock 10.

When the Delay_Req message transmitted from the client device 20 is received at time T4, the boundary clock 10 transmits a Delay_Resp message to the client device 20 in response to the Delay_Req message (step S23). The boundary clock 10 includes a timestamp indicating time T4 (fourth time), which is the reception time of the Delay_Req message in the Delay_Resp message, and transmits the resulting Delay_Resp message to the client device 20.

The BC-client offset calculation processing unit 34 acquires the PTP packet in which the message transmitted and received between the boundary clock 10 and the client device 20 is copied at a copy point between the boundary clock 10 and the client device 20.

That is, the BC-client offset calculation processing unit 34 acquires the PTP packet P1 (first packet) obtained by copying the PTP packet included in the Sync message. The PTP packet P1 is a packet transmitted from the boundary clock 10 serving as the first device 3 to the client device 20 serving as the second device 4, and includes time T1 (first time) which is a transmission time of the packet.

The BC-client offset calculation processing unit 34 acquires the PTP packet P2 (second packet) included in the Delay_Req message. The PTP packet P2 is a packet transmitted from the client device 20 serving as the second device 4 to the boundary clock 10 serving as the first device 3 and is a packet including time T3 (third time) which is a transmission time of the packet.

The BC-client offset calculation processing unit 34 acquires the PTP packet P3 (third packet) included in the Delay_Resp message. The PTP packet P3 is a packet transmitted from the boundary clock 10 serving as the first device 3 to the client device 20 serving as the second device 4, and is a packet including time T4 (fourth time) which is a reception time of the PTP packet P2 (second packet) included in the Delay_Req message.

The BC-client offset calculation processing unit 34 acquires time T1 from the acquired PTP packet P1. The BC-client offset calculation processing unit 34 acquires time T3 from the acquired PTP packet P2. The BC-client offset calculation processing unit 34 acquires time T4 from the acquired PTP packet P3.

The BC-client offset calculation processing unit 34 calculates the second offset by the following Expression (1) based on times T1 to T4.

$$Second offset = ( ( T 2 - T 1 ) - ( T 4 - T 3 ) ) / 2 \qquad Expession ( 1 )$$

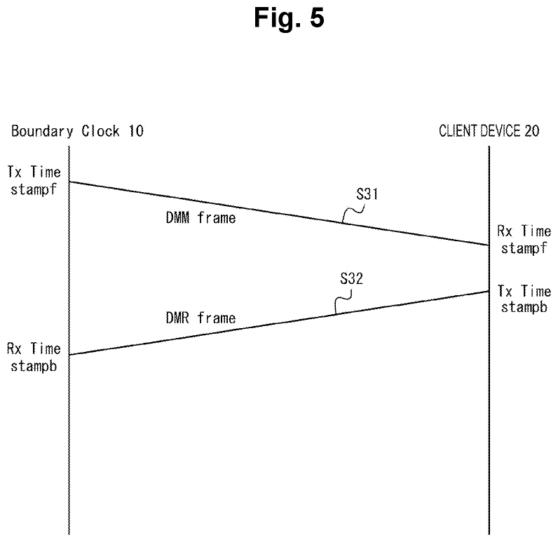

As described above, the BC-client offset calculation processing unit 34 can receive times T1, T3, and T4 from the copy of the acquired PTP packet. However, since time T2 which is the reception time of the Sync message by the client device 20 cannot be acquired from the PTP packet, it is necessary for the BC-client offset calculation processing unit 34 to separately acquire time T2. As a method of acquiring time T2, there is a method of using a transmission delay between the boundary clock 10 and the client device 20. The transmission delay between the boundary clock 10 and the client device 20 is calculated by the transmission delay calculation processing unit 16 by transmitting and receiving the transmission delay measurement packet between the boundary clock 10 and the client device 20. Hereinafter, the calculation of the transmission delay by the transmission delay calculation processing unit 16 will be described below with reference to FIG. 5.

In FIG. 5, a method in which Ethernet (registered trademark) delay measurement (ETH-DM) is used will be described. The ETH-DM is a delay measurement method defined in JT-Y 1731 OAM functions and mechanisms for Ethernet based networks. The ETH-DM includes two methods of 1WAY ETH-DM and 2WYA ETH-DM. Hereinafter, a case in which 2WAY ETH-DM is used will be described as an example.

As illustrated in FIG. 5, the transmission delay measurement packet transceiver unit 15 of the boundary clock 10 transmits a DMM frame to the client device 20 (step S31). When the DMM frame is received, the transmission delay measurement packet transceiver unit 23 of the client device 20 transmits the DMR frame to the boundary clock 10 (step S32). Hereinafter, the transmission time of the DMM frame by the boundary clock 10 is referred to as Tx Time stampf, and the reception time of the DMM frame by the client device 20 is referred to as Rx Time stampf. The transmission time of the DMR frame by the client device 20 is Tx Time stampb, and the reception time of the DMR frame by the boundary clock 10 is Rx Time stampb. The client device 20 includes the reception time Rx Time stampf of the DMM frame and the transmission time Tx Time stampb of the DMR frame in the DMR frame and transmits the DMR frame to the boundary clock 10.

The frame delay of ETH-DM (a time required for roundtrip between the boundary clock 10 and the client device 20) can be calculated by the following Expression (2).

$$Frame delay = ( Rx Time stampb - Tx Time stampf ) - ( Tx Time stampb - Rx Time stampf ) \qquad Expression ( 2 )$$

The transmission delay calculation processing unit 16 acquires Rx Time stampf and Tx Time stampb from the DMR frame received from the client device 20. The transmission delay calculation processing unit 16 can acquire Tx Time stampf and Rx Time stampb from transmission of a DMM frame and reception of a DMR frame by the transmission delay measurement packet transceiver unit 15. Accordingly, the transmission delay calculation processing unit 16 can calculate the frame delay by Expression (2). The transmission delay calculation processing unit 16 outputs a transmission result of the transmission delay (frame delay) to the measurement instrument 30.

The roundtrip transmission delay of the PTP packet between the boundary clock 10 and the client device 20 can be calculated by the following Expression (3) using times T1 to T4 described with reference to FIG. 4.

$$Roundtrip transmission delay = ( T 2 - T 1 ) + ( T 4 - T 3 ) \qquad Expression ( 3 )$$

The BC-client offset calculation processing unit 34 can calculate time T2 based on the transmission delay calculated by the transmission delay calculation processing unit 16 and Expression (3). Then, the BC-client offset calculation processing unit 34 calculates the second offset based on the following Expression (4).

$$Second offset = ( ( T 2 - T 1 ) - ( T 4 - T 3 ) ) / 2 \qquad Expression ( 4 )$$

The method of calculating the transmission delay described with reference to FIG. 5 is merely exemplary, and any method may be used as long as the transmission delay can be obtained.

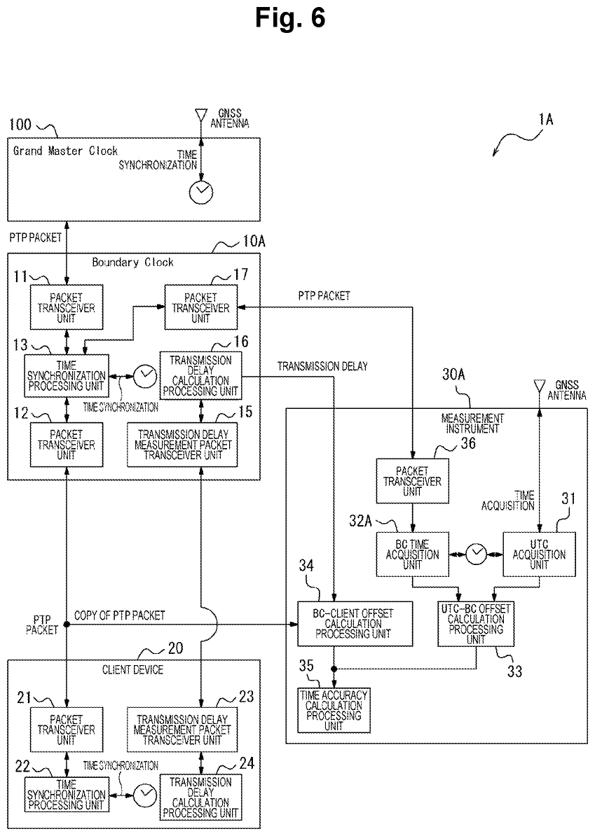

FIG. 6 is a diagram illustrating an exemplary configuration of a time synchronization system 1A according to another embodiment of the present disclosure. In FIG. 6, the same constituents as those in FIG. 2 are denoted by the same reference numerals, and the description thereof will be omitted.

As illustrated in FIG. 6, the time synchronization system 1A includes a boundary clock 10A, the client device 20, and a measurement instrument 30A. The time synchronization system 1A illustrated in FIG. 6 is different from the time synchronization system 1 illustrated in FIG. 2 in that the boundary clock 10 and the measurement instrument 30 are changed to a boundary clock 10A and a measurement instrument 30A, respectively.

The boundary clock 10A includes packet transceiver units 11, 12, and 17, a time synchronization processing unit 13, a transmission delay measurement packet transceiver unit 15, and a transmission delay calculation processing unit 16. The boundary clock 10A illustrated in FIG. 6 is different from boundary clock 10 illustrated in FIG. 2 in that 1PPS transmission unit 14 is removed and the packet transceiver unit 17 is added.

The packet transceiver unit 17 transmits and receives a PTP packet to and from the measurement instrument 30A.

The measurement instrument 30A includes the UTC acquisition unit 31, the BC time acquisition unit 32A, the UTC-BC offset calculation processing unit 33, the BC-client offset calculation processing unit 34, the time accuracy calculation processing unit 35, and a packet transceiver unit 36. The measurement instrument 30A illustrated in FIG. 6 is different from the measurement instrument 30 illustrated in FIG. 2 in that a packet transceiver unit 36 is added and that the BC time acquisition unit 32 is changed to a BC time acquisition unit 32A.

The packet transceiver unit 36 transmits and receives a PTP packet to and from the boundary clock 10A, and outputs the received PTP packet to the BC time acquisition unit 32A.

The BC time acquisition unit 32A acquires time information from the PTP packet output from the packet transceiver unit 36. That is, the BC time acquisition unit 32A serving as the second acquisition unit acquires the PTP packet including time information regarding the in-device time of the boundary clock 10 serving as the first device 3 from the boundary clock 10 and acquires the time information from the acquired PTP packet.

In this way, in the time synchronization system 1A illustrated in FIG. 6, the BC time acquisition unit 32A acquires the time information from the PTP packet transmitted from the boundary clock 10. In the time synchronization system 1 illustrated in FIG. 2, the BC time acquisition unit 32 acquires time information from the 1PPS signal. Therefore, in the time synchronization system 1, it is necessary to connect the measurement instrument 30 to the client device 20 by a coaxial cable for transmitting a 1PPS signal, and there is a constraint on an installation location of the measurement instrument 30. On the other hand, in the time synchronization system 1A illustrated in FIG. 6, since it is sufficient that the PTP packet can be transmitted and received between the boundary clock 10A and the measurement instrument 30A, the constraint on the installation place of the measurement instrument 30A is further relaxed, and the measurement can be performed more easily.

The other configurations and operations in the time synchronization system 1A illustrated in FIG. 6 are similar to those of the time synchronization system 1 illustrated in FIG. 2, and thus, description thereof is omitted.

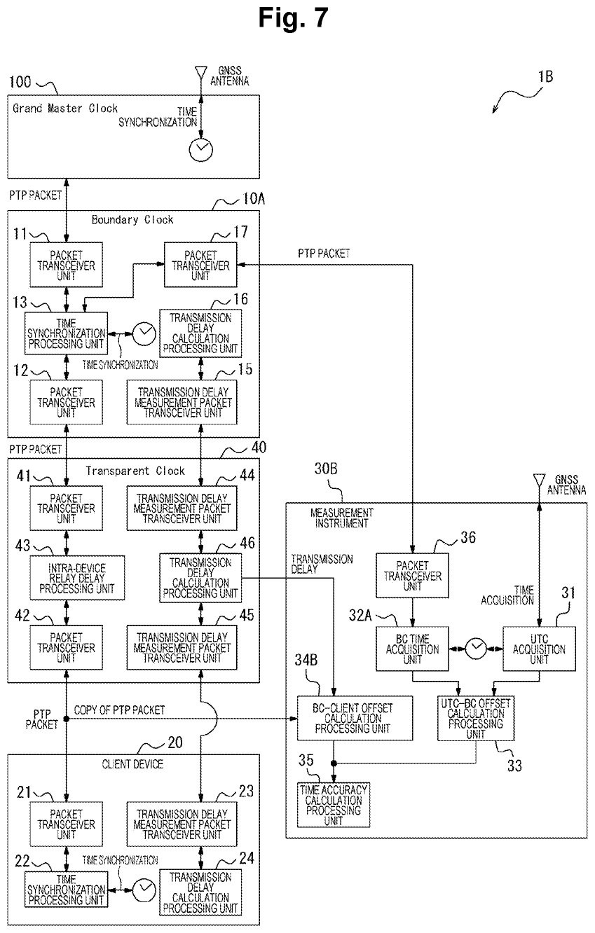

Next, a configuration of a time synchronization system 1B according to still another embodiment of the present disclosure will be described with reference to FIG. 7.

A time synchronization system 1B illustrated in FIG. 7 includes a boundary clock 10A, a client device 20, a measurement instrument 30B, and a transparent clock 40. The time synchronization system 1B illustrated in FIG. 7 is different from the time synchronization system 1A illustrated in FIG. 6 in that a measurement instrument 30A is changed to a measurement instrument 30B and a transparent clock 40 is added.

The transparent clock 40 serving as the third device is provided between the boundary clock 10A serving as the first device 3 and the client device 20 serving as the second device 4 and relays the PTP packet between the boundary clock 10 and the client device 20.

As illustrated in FIG. 7, the transparent clock 40 includes packet transceiver units 41 and 42, an intra-device relay delay processing unit 43, transmission delay measurement packet transceiver units 44 and 45, and a transmission delay calculation processing unit 46.

The packet transceiver unit 41 transmits and receives a PTP packet to and from the boundary clock 10A. The packet transceiver unit 42 transmits and receives a packet to and from the client device 20.

The intra-device relay delay processing unit 43 measures the time required for the relay processing of the PTP packet in the transparent clock 40, and notifies a distribution destination of the PTP packet.

The transmission delay measurement packet transceiver unit 44 transmits and receives a transmission delay measurement packet to and from the boundary clock 10. The transmission delay measurement packet transceiver unit 45 transmits and receives the transmission delay measurement packet to and from the client device 20.

The transmission delay calculation processing unit 46 calculates a transmission delay between the boundary clock 10A and the transparent clock 40 based on the transmission delay measurement packet transmitted to and received from the boundary clock 10A by the transmission delay measurement packet transceiver unit 44. The transmission delay calculation processing unit 46 calculates a transmission delay between the client device 20 and the transparent clock 40 based on the transmission delay measurement packet transmitted to and received from the client device 20 by the transmission delay measurement packet transceiver unit 45. That is, the transmission delay calculation processing unit 46 calculates a transmission delay between the boundary clock 10A serving as the first device 3 and the transparent clock 40 (third device) and a transmission delay between the client device 20 serving as the second device 4 and the transparent clock 40. The transmission delay calculation processing unit 46 outputs the calculation result of the transmission delay to the measurement instrument 30B.

The measurement instrument 30B includes the UTC acquisition unit 31, the BC time acquisition unit 32A, the UTC-BC offset calculation processing unit 33, the BC-client offset calculation processing unit 34B, the time accuracy calculation processing unit 35, and the packet transceiver unit 36. The measurement instrument 30B illustrated in FIG. 7 is different from the measurement instrument 30A illustrated in FIG. 6 in that the BC-client offset calculation processing unit 34 is changed to a BC-client offset calculation processing unit 34B.

The BC-client offset calculation processing unit 34B serving as the second calculation processing unit acquires calculation results of transmission delay between the boundary clock 10A and the transparent clock 40 and the transmission delay between the client device 20 and the transparent clock 40 by the transmission delay calculation processing unit 46. The BC-client offset calculation processing unit 34B acquires a copy of the PTP packet transmitted and received between the transparent clock 40 and the client device 20. The BC-client offset calculation processing unit 34B calculates the second offset based on the acquired calculation result of the transmission delay and (a copy of) the PTP packet.

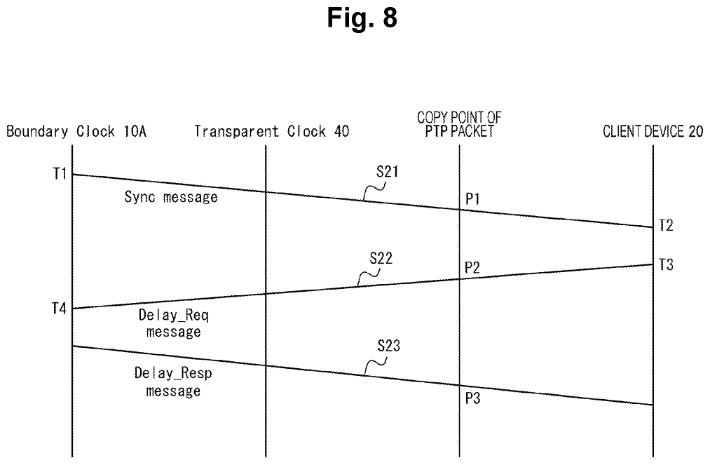

Next, calculation of the second offset by the BC-client offset calculation processing unit 34B will be described with reference to FIG. 8. As described with reference to FIG. 4, the boundary clock 10A first transmits a Sync message to the client device 20 (step S21). The boundary clock 10A includes a timestamp indicating time T1 (first time) in the Sync message and transmits the Sync message to the client device 20. The Sync message is transmitted to the client device 20 via the transparent clock 40.

When the Sync message is received at time T2 (second time), the client device 20 transmits the Delay_Req message to the boundary clock 10A at time T3 in accordance with the Sync message (step S22). The client device 20 includes a timestamp indicating time T3 (third time) which is the transmission time of the Delay_Req message in the Delay_Req message, and transmits the Delay_Req message to the boundary clock 10A. The Delay_Req message is transmitted to the boundary clock 10A via the transparent clock 40.

When the Delay_Req message is received at time T4, the boundary clock 10A transmits the Delay_Resp message to the client device 20 in accordance with the Delay_Req message (step S23). The boundary clock 10A includes a timestamp indicating time T4 (fourth time) in Delay_Resp message, and transmits the Delay_Resp message to the client device 20.

Hereinafter, the reception time of the Sync message by the transparent clock 40 is denoted by dt1, and the transmission time of the Sync message is denoted by dt2. The reception time of the Delay_Req message by the transparent clock 40 is denoted by dt3, and the transmission time of the Delay_Req message is denoted by dt4.

The BC-client offset calculation processing unit 34B acquires time T1 and a relay delay time dt2-dt1 from the PTP packet P1 to which the PTP packet constituting the Sync message has been copied.

Subsequently, the BC-client offset calculation processing unit 34B acquires time T3 from the PTP packet P2 to which the PTP packet included in the Delay_Req message has been copied.

Subsequently, the BC-client offset calculation processing unit 34B acquires time T4 from the PTP packet P3 to which the PTP packet included in the Delay_Resp message has been copied. The BC-client offset calculation processing unit 34B acquires a relay delay time dt4-dt3 of the Delay_Req message in the transparent clock 40 from the PTP packet P3.

The BC-client offset calculation processing unit 34B calculates the second offset by the following Expression (5) based on times T1 to T4, the relay delay time dt2-dt1, and the relay delay time dt4-dt3.

$$Second offset = ( ( T 2 - T 1 ) \_ ( T 4 - T 3 ) - ( dt 2 - dt 1 ) - ( dt 4 - dt 3 ) ) / 2 \qquad Expression ( 5 )$$

A method of calculating the second offset by the BC-client offset calculation processing unit 34B is not limited to the method in which the above-described Expression (5) is used. Another method of calculating the second offset by the BC-client offset calculation processing unit 34B will be described. Hereinafter, a transmission delay time between the boundary clock 10A and the transparent clock 40 is defined as pt1, and a transmission delay time between the transparent clock 40 and the client device 20 is defined as pt2.

As described with reference to FIG. 8, the BC-client offset calculation processing unit 34B acquires time T1, the relay delay time dt2-dt1, and the transmission delay time pt1 from the PTP packet P1. The transmission delay time pt1 can be measured in accordance with, for example, a peer-to-peer mechanism (P2P) method. The P2P method is a method of measuring a transmission delay time between devices physically connected by a cable.

The BC-client offset calculation processing unit 34B calculates the second offset in accordance with the following Expression (6) based on times T1 and T2, the relay delay time dt2-dt1, the transmission delay time pt1 between the boundary clock 10A and the transparent clock 40, and the transmission delay time pt2 between the transparent clock 40 and the client device 20.

$$Second offset = ( T 2 - T 1 ) - pt 1 - pt 2 - ( dt 2 - dt 1 ) \qquad Expression ( 6 )$$

The BC-client offset calculation processing unit 34B cannot acquire time T2 and the transmission delay time pt2 from the PTP packet. Therefore, in the case of using Expression (5), the BC-client offset calculation processing unit 34B needs to separately acquire time T2. When Expression (6) is used, it is necessary for the BC-client offset calculation processing unit 34B to separately acquire time T2 and the transmission delay time pt2.

As a method by which the client device 20 acquires time T2, for example, there is a method using ETH-DM described with reference to FIG. 5. By using ETH-DM, the transmission delay calculation processing unit 46 of the transparent clock 40 can calculate a frame delay (a time required for DMM frame to reciprocate between the transparent clock 40 and the client device 20) between the transparent clock 40 and the client device 20. The BC-client offset calculation processing unit 34B can calculate time T2 based on the frame delay calculated by the transmission delay calculation processing unit 46.

As another method by which the client device 20 acquires time T2, there is a method using the PTP packet described with reference to FIG. 4. From FIG. 4, the roundtrip transmission delay between the boundary clock 10A and the client device 20 is expressed by the following Expression (7).

$$Roundtrip transmission delay = ( T 2 - T 1 ) + ( T 4 - T 3 ) - ( dt 2 - dt 1 ) - ( dt 4 - dt 3 ) \qquad Expression ( 7 )$$

In Expression (7), times T1, T3, and T4, the relay delay time dt2-dt1, and the relay delay time dt4-dt3 can be acquired from the PTP packet. The roundtrip transmission delay can be calculated by ETH-DM. Accordingly, the BC-client offset calculation processing unit 34B can calculate time T2 based on Expression (7) using times T1, T3, and T4, the relay delay time dt2-dt1 and the relay delay time dt4-dt3 acquired from the PTP packet, and the roundtrip transmission delay calculated by the ETH-DM.

As still another method of acquiring time T2 by the client device 20, there is a method using times T1 and T2 described with reference to FIG. 4. The roundtrip transmission delay between the boundary clock 10A and the client device 20 is expressed by the following Expression (8).

$$Roundtrip transmission delay = ( ( T 2 - T 1 ) - ( dt 2 - dt 1 ) ) * 2 \qquad Expression ( 8 )$$

In Expression (8), T1 and dt2-dt1 can be obtained from the PTP packet. The roundtrip transmission delay can be calculated by ETH-DM. Accordingly, the BC-client offset calculation processing unit 34B can calculate time T2 based on Expression (8) using T1 and dt2-dt1 acquired from the PTP packet and the roundtrip transmission delay calculated by ETH-DM.

Next, a hardware configuration of the measurement instrument 30 according to the present disclosure will be described. In the following description, the measurement instrument 30 will be described as an example, but the same applies to the measurement instruments 30A and 30B.

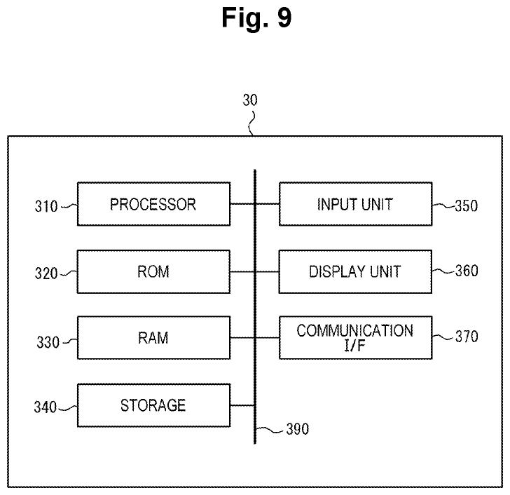

FIG. 9 is a diagram illustrating an example of a hardware configuration of the measurement instrument 30 according to an embodiment of the present disclosure. FIG. 9 illustrates an example of a hardware configuration of the measurement instrument 30 when the measurement instrument 30 is configured with a computer capable of executing a program command. Here, the computer may be a general-purpose computer, a dedicated computer, a workstation, a personal computer (PC), an electronic note pad, or the like. The program command may be a program code, a code segment, or the like for executing a necessary task.

As illustrated in FIG. 9, the measurement instrument 30 includes a processor 310, a read only memory (ROM) 320, a random access memory (RAM) 330, a storage 340, an input unit 350, a display unit 360, and a communication interface (I/F) 370. These configurations are communicably connected via a bus 390 to be able to communicate with each other. Specifically, the processor 310 is a central processing unit (CPU), a micro processing unit (MPU), a graphics processing unit (GPU), a digital signal processor (DSP), a system on a chip (SoC), or the like and may be configured with the same type or different types of a plurality of processors.

The processor 310 is a controller that executes control of each configuration and various types of arithmetic processing. That is, the processor 310 reads the program from the ROM 320 or the storage 340, and executes the program using the RAM 330 as a work area. The processor 310 performs control of each of the above-described configurations and various types of arithmetic processing according to a program stored in the ROM 320 or the storage 340. In the present embodiment, the ROM 120 or the storage 140 stores a program causing a computer to function as the measurement instrument 30 according to the present disclosure. The program is read and executed by the processor 310 to implement each configuration of the measurement instrument 30, that is, the UTC acquisition unit 31, the BC time acquisition unit 32, the UTC-BC offset calculation processing unit 33, the BC-client offset calculation processing unit 34, and the time accuracy calculation processing unit 35.

The program may be provided in a form in which the program is stored in a non-transitory storage medium, such as a compact disk read only memory (CD-ROM), a digital versatile disk read only memory (DVD-ROM), and a universal serial bus (USB) memory. The program may be downloaded from an external device via a network.

The ROM 320 stores various programs and various types of data. The RAM 330 serving as a work area temporarily stores programs or data. The storage 340 includes a hard disk drive (HDD) or a solid state drive (SSD) and stores various programs including an operating system and various types of data.

The input unit 350 includes a pointing device such as a mouse and a keyboard and is used to perform various inputs.

The display unit 360 is, for example, a liquid crystal display and displays various types of information. A touch panel system may be adopted so that the display unit 360 can function as the input unit 350.

The communication interface 370 is an interface communicating with another device such as an external device (not illustrated). For example, a standard such as Ethernet (registered trademark), FDDI, and Wi-Fi (registered trademark) is used.

A computer can be suitably used to function as each unit of the above-described measurement instrument 30. Such a computer can be implemented by storing a program describing processing content for implementing the function of each unit of the measurement instrument 30 in a storage unit of the computer, and reading and executing the program by a processor of the computer. That is, the program can cause the computer to function as the above-described measurement instrument 30. The program can be recorded in a non-transitory recording medium. The program can also be provided via a network.

With regard to the above embodiments, the following supplements will be further disclosed.

### (Supplement 1)

A measurement instrument that measures accuracy of an in-device time of a second device with respect to a reference time in the second device that synchronizes the in-device time with the reference time and synchronizes the in-device time with the first device by transmitting and receiving a packet to and from the first device that delivers the in-device time, the measurement instrument including a processor:
wherein the processor
acquires the reference time from a satellite signal,
acquires time information regarding an in-device time of the first device,
calculates a first offset that is a difference between the reference time and the in-device time of the first device based on the acquired reference time and the acquired time information acquired by the second acquisition unit,
acquires a copy of the packet transmitted and received between the first and second devices, and calculates a second offset that is a difference between the in-device time of the first device and the in-device time of the second device based on the acquired packet and a transmission delay between the first and second devices, and
measures accuracy of the in-device time of the second device with respect to the reference time based on the first and second offsets.

### (Supplement 2)

The measurement instrument according to Supplement 1, wherein the processor acquires copies of a first packet that is a packet transmitted from the first device to the second device and includes a first time which is a transmission time of the packet, a second packet that is a packet transmitted from the second device to the first device in accordance with the first packet and includes a third time which is a transmission time of the packet, and a third packet that is a packet transmitted from the first device to the second device in accordance with the second packet and includes a fourth time which is a reception time of the second packet by the first device, calculates a second time that is a reception time of the first packet by the second device based on the first time, the third time, and the fourth time included in the first to third packets and the transmission delay, and calculates the second offset based on the first time, the second time, the third time, and the fourth time.

### (Supplement 3)

The measurement instrument according to Supplement 1, wherein the processor acquires the time information based on a pulse signal output from the first device at 1PPS in synchronization with the in-device time of the first device.

### (Supplement 4)

The measurement instrument according to Supplement 1, wherein the processor acquires a packet including time information regarding the in-device time of the first device from the first device, and acquires the time information from the acquired packet.

### (Supplement 5)

The measurement instrument according to Supplement 1, wherein
wherein a third device that relays the packet is provided between the first and second devices,
wherein the third device calculates a transmission delay between the first and third devices and a transmission delay between the second and third devices; and
wherein the processor calculates the second offset based on a calculation result of the third device.

### (Supplement 6)

A measurement method by a measurement instrument that measures accuracy of an in-device time of a second device with respect to a reference time in the second device that synchronizes the in-device time with the reference time and synchronizes the in-device time with the first device by transmitting and receiving a packet to and from the first device that delivers the in-device time, the measurement method comprising:
a step of acquiring the reference time from a satellite signal;
a step of acquiring time information regarding an in-device time of the first device;
a step of calculating a first offset that is a difference between the reference time and the in-device time of the first device based on the acquired reference time and the acquired time information;
a step of acquiring a copy of the packet transmitted and received between the first and second devices, and calculating a second offset that is a difference between the in-device time of the first device and the in-device time of the second device based on the acquired packet and a transmission delay between the first and second devices; and
a step of measuring accuracy of the in-device time of the second device with respect to the reference time based on the first and second offsets.

### (Supplement 7)

A time synchronization system comprising:
a first device configured to synchronize an in-device time with a reference time and deliver the in-device time;
a second device configured to synchronize an in-device time with the first device by transmitting and receiving a packet to and from the first device; and
a measurement instrument configured to measure accuracy of an in-device time of the second device with respect to the reference time in the second device,
wherein the measurement instrument includes a processor:
wherein the processor
acquires the reference time from a satellite signal;
a second acquisition unit configured to acquire time information regarding an in-device time of the first device;
calculates a first offset that is a difference between the reference time and the in-device time of the first device based on the reference time acquired by the first acquisition unit and the time information acquired by the second acquisition unit;
acquires a copy of the packet transmitted and received between the first and second devices, and calculates a second offset that is a difference between the in-device time of the first device and the in-device time of the second device based on the acquired packet and a transmission delay between the first and second devices; and
measures accuracy of the in-device time of the second device with respect to the reference time based on the first and second offsets.

Although the above-described embodiments have been described as representative examples, it is apparent to those skilled in the art that many modifications and substitutions can be made within the spirit and scope of the present disclosure. Accordingly, it should not be understood that the present invention is limited by the above-described embodiments, and various modifications or changes can be made without departing from the scope of the claims. For example, a plurality of configuration blocks described in the configuration diagrams of the embodiments can be combined into one, or one configuration block can be divided.

### REFERENCE SIGNS LIST

1 Time synchronization system
2 Network
3 First device
4 Second device
10, 10A Boundary Clock
11, 12, 17 Packet transceiver unit
13 Time synchronization processing unit
14 1PPS transmission unit
15 Transmission delay measurement packet transceiver unit
16 Transmission delay calculation processing unit
20 Client device
21 Packet transceiver unit
22 Time synchronization processing unit
23 Transmission delay measurement packet transceiver unit
24 Transmission delay calculation processing unit
30, 30A, 30B Measurement instrument
31 UTC acquisition unit (first acquisition unit)
32 BC time acquisition unit (second acquisition unit)
33 UTC-BC offset calculation processing unit (first calculation processing unit)
34 BC-client offset calculation processing unit (second calculation processing unit)
35 Time accuracy calculation processing unit (third calculation processing unit)
36 Packet transceiver unit
40 Transparent clock
41, 42 Packet transceiver unit
43 Intra-device relay delay processing unit
44, 45 Transmission delay measurement packet transceiver unit
46 Transmission delay calculation processing unit
100 Grand master clock
310 Processor
320 ROM
330 RAM
340 Storage
350 Input unit
360 Display unit
370 Communication I/F
390 Path

1. A measurement instrument comprising a processor configured to execute operations comprising:
acquiring a reference time from a satellite signal;
acquiring time information regarding an in-device time of the first device;
calculating a first offset that is a difference between the reference time and the in-device time of a first device based on the reference time and the time information;
acquiring a copy of a packet transmitted and received between the first and second devices;
calculating a second offset that is a difference between the in-device time of the first device and the in-device time of the second device based on the acquired packet and a transmission delay between the first and second devices; and
measuring a degree of accuracy of the in-device time of the second device with respect to the reference time based on the first and second offsets.

2. The measurement instrument according to claim 1, wherein the acquiring the copy of packet further comprises:
acquiring copies of:
a first packet transmitted from the first device to the second device and includes a first time which is a transmission time of the first packet,
a second packet transmitted from the second device to the first device in accordance with the first packet and includes a third time which is a transmission time of the second packet, and
a third packet transmitted from the first device to the second device in accordance with the second packet and includes a fourth time which is a reception time of the second packet by the first device,
calculating a second time that is a reception time of the first packet by the second device based on the first time, the third time, and the fourth time included in the first to third packets and the transmission delay, and
calculating the second offset based on the first time, the second time, the third time, and the fourth time.

3. The measurement instrument according to claim 1, wherein the acquiring the time information further comprises acquiring the time information based on a pulse signal output from the first device at one pulse per second in synchronization with the in-device time of the first device.

4. The measurement instrument according to claim 1, wherein the acquiring the time information further comprises:
acquiring the packet including time information regarding the in-device time of the first device from the first device, and
acquiring the time information from the acquired packet.

5. The measurement instrument according to claim 1,
wherein a third device that relays the packet is provided between the first and second devices,
wherein the third device calculates a transmission delay between the first and third devices and a transmission delay between the second and third devices; and
wherein the second calculation processing unit calculates the second offset based on a calculation result of the third device.

6. A measurement method, comprising:
acquiring the reference time from a satellite signal;
acquiring time information regarding an in-device time of the first device;
calculating a first offset that is a difference between the reference time and the in-device time of the first device based on the acquired reference time and the acquired time information;
acquiring a copy of a packet transmitted and received between the first and second devices;
calculating a second offset that is a difference between the in-device time of the first device and the in-device time of the second device based on the acquired packet and a transmission delay between the first and second devices; and
measuring a degree of accuracy of the in-device time of the second device with respect to the reference time based on the first and second offsets.

7. A time synchronization system comprising a processor configured to execute operations comprising:
synchronizing, using a first device, an in-device time with a reference time;
transmitting the in-device time;
synchronizing, using a second device, an in-device time with the first device by transmitting and receiving a packet to and from the first device; and
measuring a degree of accuracy of an in-device time of the second device with respect to the reference time in the second device,
wherein the measuring further comprises:
acquiring the reference time from a satellite signal,
acquiring time information regarding an in-device time of the first device,
calculating a first offset that is a difference between the reference time and the in-device time of the first device based on the reference time and the time information,
acquiring a copy of the packet transmitted and received between the first and second devices,
calculating a second offset that is a difference between the in-device time of the first device and the in-device time of the second device based on the acquired packet and a transmission delay between the first and second devices, and
measuring the degree of accuracy of the in-device time of the second device with respect to the reference time based on the first and second offsets.

8. The measurement instrument according to claim 2, wherein the acquiring the time information further comprises acquiring the time information based on a pulse signal output from the first device at one pulse per second in synchronization with the in-device time of the first device.

9. The measurement instrument according to claim 2, wherein the acquiring the time information further comprises:
acquiring the packet including time information regarding the in-device time of the first device from the first device, and
acquiring the time information from the acquired packet.

10. The measurement method according to claim 6, wherein the acquiring the copy of packet further comprises:
acquiring copies of:
a first packet transmitted from the first device to the second device and includes a first time which is a transmission time of the first packet,
a second packet transmitted from the second device to the first device in accordance with the first packet and includes a third time which is a transmission time of the packet, and
a third packet transmitted from the first device to the second device in accordance with the second packet and includes a fourth time which is a reception time of the second packet by the first device,
calculating a second time that is a reception time of the first packet by the second device based on the first time, the third time, and the fourth time included in the first to third packets and the transmission delay, and
calculating the second offset based on the first time, the second time, the third time, and the fourth time.

11. The measurement method according to claim 6, wherein the acquiring the time information further comprises acquiring the time information based on a pulse signal output from the first device at one pulse per second in synchronization with the in-device time of the first device.

12. The measurement method according to claim 6, wherein the acquiring the time information further comprises:
acquiring the packet including time information regarding the in-device time of the first device from the first device, and
acquiring the time information from the acquired packet.

13. The measurement method according to claim 6, wherein a third device that relays the packet is provided between the first and second devices,
wherein the third device calculates a transmission delay between the first and third devices and a transmission delay between the second and third devices, and
wherein the second calculation processing unit calculates the second offset based on a calculation result of the third device.

14. The measurement method according to claim 10, wherein the acquiring the time information further comprises acquiring the time information based on a pulse signal output from the first device at one pulse per second in synchronization with the in-device time of the first device.

15. The measurement method according to claim 10, wherein the acquiring the time information further comprises:
acquiring the packet including time information regarding the in-device time of the first device from the first device, and
acquiring the time information from the acquired packet.

16. The time synchronization system according to claim 7, wherein the acquiring the copy of the packet further comprises:
acquiring copies of:
a first packet transmitted from the first device to the second device and includes a first time which is a transmission time of the packet,
a second packet transmitted from the second device to the first device in accordance with the first packet and includes a third time which is a transmission time of the packet, and
a third packet transmitted from the first device to the second device in accordance with the second packet and includes a fourth time which is a reception time of the second packet by the first device,
calculating a second time that is a reception time of the first packet by the second device based on the first time, the third time, and the fourth time included in the first to third packets and the transmission delay, and
calculating the second offset based on the first time, the second time, the third time, and the fourth time.

17. The time synchronization system according to claim 7, wherein the acquiring the time information further comprises acquiring the time information based on a pulse signal output from the first device at one pulse per second in synchronization with the in-device time of the first device.

18. The time synchronization system according to claim 7, wherein the acquiring the time information further comprises:
acquiring the packet including time information regarding the in-device time of the first device from the first device, and
acquiring the time information from the acquired packet.

19. The time synchronization system according to claim 7, wherein a third device that relays the packet is provided between the first and second devices,
wherein the third device calculates a transmission delay between the first and third devices and a transmission delay between the second and third devices, and
wherein the second calculation processing unit calculates the second offset based on a calculation result of the third device.

20. The time synchronization system according to claim 16, wherein the acquiring the time information further comprises acquiring the time information based on a pulse signal output from the first device at one pulse per second in synchronization with the in-device time of the first device.
